(19) United States
(12) Patent Application Publication
(10) Pub. No.: US 2022/0240210 A1
(43) Pub. Date: Jul. 28, 2022

(54) Onboarding Network Procedures for UE and Network

(71) Applicant: MEDIATEK INC., Hsin-Chu (TW)

(72) Inventors: Chia-Lin Lai, Hsin-Chu (TW); Yuan-Chieh Lin, Hsin-Chu (TW); Chien-Chun Huang-Fu, Hsin-Chu (TW); Guillaume Sebire, Oulu (FI); Marko Niemi, Oulu (FI)

(21) Appl. No.: 17/559,028

(22) Filed: Dec. 22, 2021

Related U.S. Application Data
(60) Provisional application No. 63/140,264, filed on Jan. 22, 2021.

(51) Int. Cl. H04W 60/00; H04W 12/06

(52) U.S. Cl. CPC H04W 60/00; H04W 12/068

(57) ABSTRACT

A method to facilitate onboarding registration via an onboarding network (ON) that is a stand-alone non-public network (ON-SNPN) is proposed. A UE is preconfigured with default UE credentials for Onboarding. UE discovers and selects an ON-SNPN and registers to the ON-SNPN using default UE credentials. Both user plane (UP) and control plane (CP) provisioning procedure can be used to obtain the SNPN credentials from a subscriber owner (SO) via an ON-SNPN access connectivity. In accordance with one novel aspect, when UE sends a registration request for UE onboarding registration, the registration request comprises information for registration type (e.g., SNPN ONBOARDING), and UE supported provisioning procedure (e.g., CP, UP, or both). Upon successful registration, UE follows the supported provisioning procedure (i.e., CP or UP) decided by the ON-SNPN to obtain the SNPN credentials from the SO-SNPN via the ON-SNPN access connectivity to a Provisioning Server (PVS).

### CROSS REFERENCE TO RELATED APPLICATIONS

This application claims priority under 35 U.S.C. § 119 from U.S. Provisional Application No. 63/140,264, entitled “Onboarding Network Procedures for UE and Network”, filed on Jan. 22, 2021, the subject matter of which is incorporated herein by reference.

### TECHNICAL FIELD

The disclosed embodiments relate generally to wireless mobile communication network, and, more particularly, to method of Onboarding via Stand-alone Non-Public Network (ON-SNPN).

### BACKGROUND

A Public Land Mobile Network (PLMN) is a network established and operated by an administration or recognized operating agency (ROA) for the specific purpose of providing land mobile communication services to the public. PLMN provides communication possibilities for mobile users. A PLMN may provide service in one or a combination of frequency bands. Access to PLMN services is achieved by means of an air interface involving radio communications between mobile phones and base stations with integrated IP network services. One PLMN may include multiple radio access networks (RAN) utilizing different radio access technologies (RAT) for accessing mobile services. A radio access network is part of a mobile communication system, which implements a radio access technology (RAT). Conceptually, RAN resides between a mobile device and provides connection with its core network (CN). Depending on the standard, mobile phones and other wireless connected devices are varyingly known as user equipment (UE), terminal equipment, mobile stations (MS), etc. Examples of different RATs include 2G GERAN (GSM) radio access network, 3G UTRAN (UMTS) radio access network, 4G E-UTRAN (LTE), 5G new radio (NR) radio access network, and other non-3GPP access RAT including WiFi.

As compared to PLMN, a non-public network (NPN) is a 5GS deployed network for non-public use. An NPN is either a Stand-alone Non-Public Network (SNPN), i.e., operated by an NPN operator and not relying on network functions provided by a PLMN; or a Public Network Integrated NPN (PNI-NPN), i.e., a non-public network deployed with the support of a PLMN. The combination of a PLMN ID and Network identifier (NID) identifies an SNPN. A UE may be enabled for SNPN. The UE selects an SNPN for which it is configured with a subscriber identifier and credentials. The UE can have several sets of subscriber identifiers, credentials, and SNPN identities.

Onboarding is the service to allow a non-provisioned UE to obtain SNPN credentials in order to get connectivity service from the SNPN. Onboarding of UFs for SNPNs allows the UE to access an onboarding network (ON) based on default UE credentials for the purpose of provisioning the UE with SNPN credentials for primary authentication and other information to enable access to a desired SNPN. An Onboarding Network (ON) refers to the network (e.g., ON-SNPN or ON-PLMN) providing connectivity to the UE via which to obtain the credentials from a subscriber owner (e.g., SO-SNPN) using User Plane (UP) or Control Plane (CP) provisioning procedure after the UE successfully registers to the ON. While normal registration refers to UE registration in a network for any purpose, onboarding registration refers to UE registration in a network for onboarding purpose only, i.e., the UE may o get connectivity from the network for the purpose of doing onboarding for obtaining the credentials of the desired SNPN. The entity that owns, stores and provides the credentials/subscription data to the UE is defined as the SO and can provide the credentials to the UE via a Provisioning Server (PVS). Information (e.g., credentials for accessing ON) that the OF may have before the actual onboarding procedure to make the UE unique identifiable and. verifiably secure is defined as default UE credentials.

A method is desired to facilitate the onboarding registration procedure for SNPN.

### SUMMARY

A method to facilitate onboarding registration via an onboarding network (ON) that is a stand-alone non-public network (ON-SNPN) is proposed. A UE is preconfigured with default UE credentials for Onboarding. UE discovers and selects an ON-SNPN and registers to the ON-SNPN using default UE credentials and/or the pre-configured information (e.g., ON-SNPN network selection information). Both user plane (UP) and control plane (CP) provisioning procedure can be used to obtain the SNPN credentials from a subscriber owner (SO) via ON-SNPN access connectivity to the provisioning server (PVS) A PVS is the entity that provides network credentials and other data in. the UF to enable SNPN access. In accordance with one novel aspect, when UE sends a registration request for UE onboarding registration, the registration request comprises information for registration type (e.g., SNPN ONBOARDING), and UE supported provisioning procedure (e.g., Control Plane (CP), User Plane (UP), or both). Upon successfully onboarding registration, UE later follows the supported provisioning procedure (i.e., CP or UP remote provisioning procedure) decided by the ON-SNPN to obtain the SNPN credentials from a subscriber owner (SO-SNPN) via the ON-SNPN access connectivity to the PVS.

In one embodiment, a UE receives an indication from a serving base station in a stand-alone non-public network (SNPN). The indication indicates that Onboarding is enabled by the SNPN. The UE transmits a registration request to the serving base station. The registration request indicates an Onboarding Registration type and one or more remote provisioning procedures supported by the UE. The UE performs an Onboarding registration to the SNPN with default UE credentials. Upon successful registration, the UE performs a selected remote provisioning procedure (either CP or UP remote provisioning procedure) with the SNPN to obtain SNPN credentials.

In another embodiment, a base station broadcasts an indication in a stand-alone non-public network (SNPN). The indication indicates that Onboarding is enabled by the SNPN. A UE indicates in an RRC signaling that a registration is for onboarding. Then, the BS selects a proper AMF of the selected SNPN based on the indication and forwards a registration request sent from the UE to the AMF. The registration request indicates an Onboarding Registration type and one or more remote provisioning procedures supported by the UE. The AMF performs Onboarding registration with the UE according to default UE credentials. Upon successful registration, a selected remote provisioning procedure is performed for providing SNPN credentials to the UE.

Other embodiments and advantages are described in the detailed description below. This summary does not purport to define the invention. The invention is defined by the claims.

### BRIEF DESCRIPTION OF THE DRAWINGS

FIG. 1 schematically shows a communication system supporting User Equipment (UE) onboarding for Stand-alone Non-public Network (SNPN) in accordance with one novel aspect.

FIG. 2 illustrates simplified block diagrams of a user equipment and a network entity in accordance with embodiments of the current invention.

FIG. 3 illustrates a simplified onboarding process for UE with an ON-SNPN.

FIG. 4 illustrates a sequence flow of a UE onboarding registration procedure with an ON-SNPN in accordance with one novel aspect.

FIG. 5 is a flow chart of a method of supporting onboarding registration procedure from UE perspective in accordance with one novel aspect.

FIG. 6 is a flow chart of a method of supporting onboarding registration procedure from BS perspective in accordance with one novel aspect.

### DETAILED DESCRIPTION

Reference will now be made in detail to some embodiments of the invention, examples of which are illustrated in the accompanying drawings.

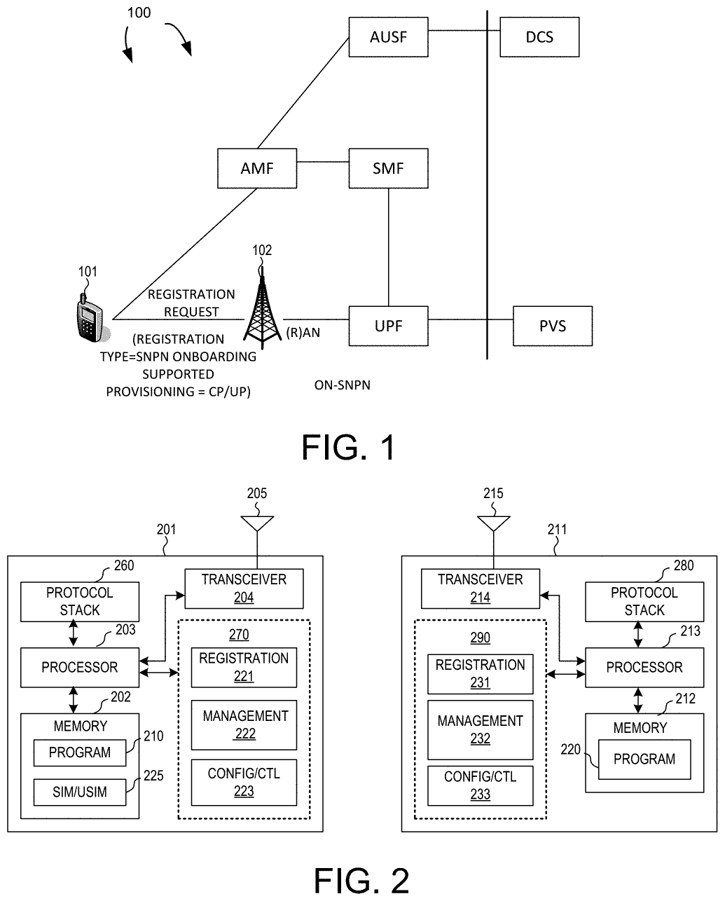

FIG. 1 schematically shows a communication system supporting User Equipment (UE) onboarding for Stand-alone Non-public Network (SNPN) in accordance with one novel aspect. Communication system 100 comprises UE 101, an Onboarding SNPN (ON-SNPN), a Default Credential Server (DCS) and a Provisioning Server (PVS). The ON-SNPN includes a radio access network (RAN), a user plane functionality (UPF), an access and mobility management function (AMF), a session management function (SMF) that provides various management services, and an authentication server function (AUSF) that interacts with DCS for primary authentication. The PVS is outside from ON-SNPN which is used to provide the credentials to the UE during onboarding procedure.

To provision. SNPN credentials in a UF, that is configured with default UE credentials, the UE discovers and selects an SNPN as ON and establishes a secure connection with that SNPN referred to as Onboarding SNPN (ON-SNPN). After the secure connection is established, the UF is provisioned with SNPN credentials to enable discovery, selection, and registration for a desired SNPN. Upon successful registration, both user plane (UP) and control plane (CP) remote provisioning procedure can be triggered by UE or network to obtain the SNPN credentials from the subscriber owner via onboarding network access connectivity to the PVS. In accordance with one novel aspect, when UE 101 sends a registration request to serving gNB 102 for UE onboarding registration, the registration request comprises information for registration type (e.g., SNPN ONBOARDING), and UE supported remote provisioning procedure (e.g., CP, UP, or both). Upon successful onboarding registration, UE 101 later follows the corresponding remote provisioning procedure (i.e., CP or UP) decided by the ON-SNPN to obtain the desired SNPN credentials from the SO-SNPN via onboarding network access connectivity to the PVS.

FIG. 2 illustrates simplified block diagrams of wireless devices, e.g., a UE 201 and network entity 211 in accordance with embodiments of the current invention. Network entity 211 may be a base station optionally combined with an AMF. Network entity 211 has an antenna 215, which transmits and receives radio signals. A radio frequency RF transceiver module 214, coupled with the antenna, receives RF signals from antenna 215, converts them to baseband signals and sends them to processor 213. RF transceiver 214 also converts received baseband signals from processor 213, converts them to RF signals, and sends out to antenna 215. Processor 213 processes the received baseband signals and invokes different functional modules to perform features in base station 211. Memory 212 stores program instructions and data 220 to control the operations of base station 211. In the example of FIG. 2, network entity 211 also includes protocol stack 280 and a set of control functional modules and circuit 290. Registration circuit 231 handles registration and mobility procedure. Management circuit 232 handles connection and session management functionalities. Configuration and control circuit 233 provides different parameters to configure and control UE.

Similarly, UE 201 has memory 202, a processor 203, and radio frequency (RF) transceiver module 204. RF transceiver 204 is coupled with antenna 205, receives RF signals from antenna 205, converts them to baseband signals, and sends them to processor 203. RF transceiver 204 also converts received baseband signals from processor 203, converts them to RF signals, and sends out to antenna 205. Processor 203 processes the received baseband signals and invokes different functional modules and circuits to perform features in UE 201. Memory 202 stores data and program instructions 210 to be executed by the processor to control the operations of UE 201. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines. A processor in associated with software may be used to implement and configure features of UE 201.

UE 201 also comprises a set of functional modules and control circuits to carry out functional tasks of UE 201. Protocol stacks 260 comprise Non-Access-Stratum (NAS) layer to communicate with an AMF entity connecting to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. System modules and circuits 270 may be implemented and configured by software, firmware, hardware, and/or combination thereof. The function modules and circuits, when executed by the processors via program instructions contained in the memory, interwork with each other to allow UE 201 to perform embodiments and functional tasks and features in the network.

In one example, system modules and circuits 270 comprise registration circuit 221 that performs onboarding registration procedure with the network, a connection and session management circuit 222 that handles the connection and session management, a config and control circuit 223 that handles configuration and control parameters. For example, when UE 201 sends a registration request to a serving gNB for UE onboarding registration, the registration request comprises information for registration type (e.g., SNPN ONBOARDING), and UE supported remote provisioning procedure (e.g., CP, UP, or both). Upon successfully onboarding registration, UE 201 later follows the corresponding remote provisioning procedure (i.e., CP or UP) decided by the ON-SNPN to obtain the SNPN credentials from the SO-SNPN.

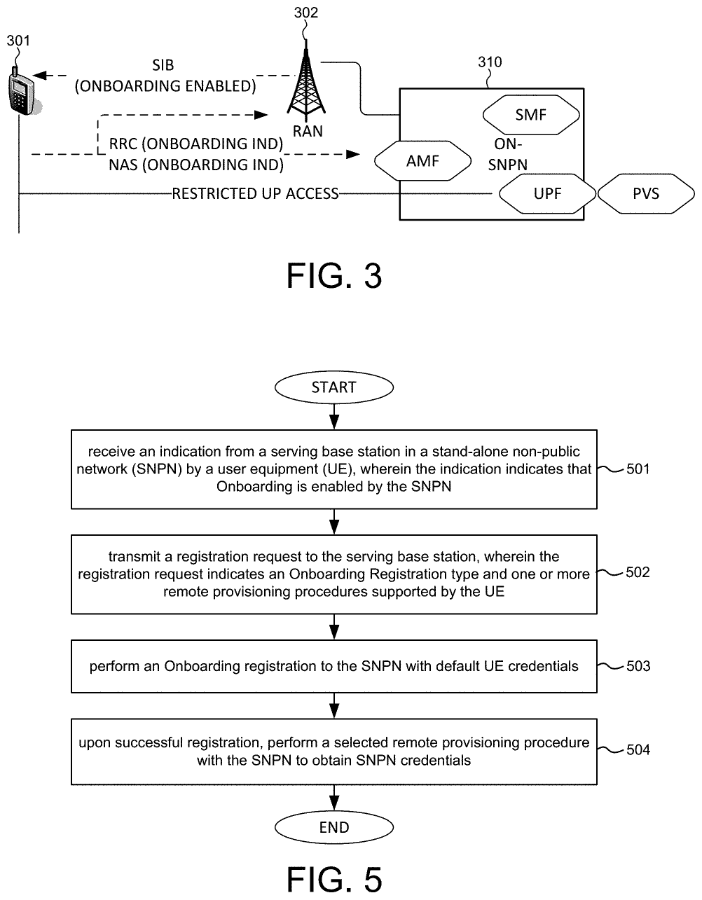

FIG. 3 illustrates a simplified onboarding process for UE 301 with an ON-SNPN 310. Typically, an SNPN that allows onboarding procedure will broadcast an indication at cell level that onboarding is supported. An “Onboarding Enabled” indication is broadcasted in the System Information Block (SIB) to inform UEs that the network supports Onboarding service. A UE is not allowed to access an SNPN and perform an Onboarding registration in this SNPN if the SNPN is not broadcasting this indication. A UE is only allowed to access an SNPN and perform Onboarding registration in this SNPN if the SNPN is broadcasting this indication. The SIB indication is broadcast by NG-RAN at cell level.

In the example of FIG. 3, UE 301, who wants to be provisioned with SNPN credentials for connectivity service from the SNPN, will signal to the network with onboarding request in both radio resource control signaling (RRC) and non-access stratum signaling (NAS). This allows the NG-RAN 302 to forward the request from the UE to a dedicated onboarding access and mobility management function (AMF) of the ON-SNPN 310. The AMF uses the NAS level indication to select a session management function (SMF) used for remote provisioning and to set up a restricted user plane between the UE and the provisioning server (PVS). Under UP provisioning, after a PDU session is set up, the application in the UE then interacts with the PVS to obtain the SNPN credentials. Once UE has received the SNPN credentials from the PVS, UE will restart and use the SNPN credentials to access the network.

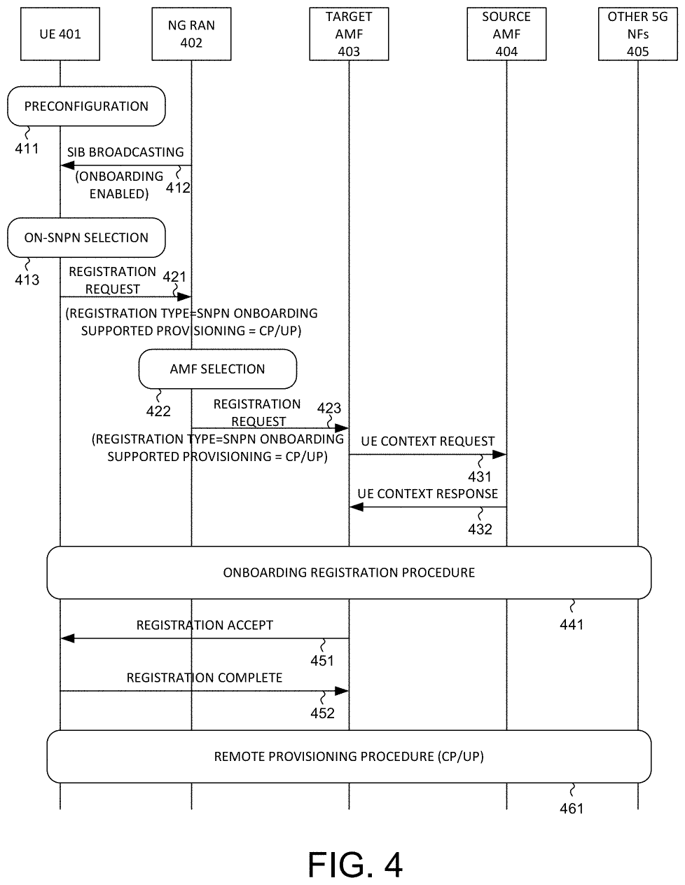

FIG. 4 illustrates a sequence flow of an onboarding registration procedure between a UE and an ON-SNPN in accordance with one novel aspect. UE enabled to support UE Onboarding should be pre-configured with Default UE credentials before the actual onboarding procedure. The default UE credentials make the UE uniquely identifiable and verifiably secure, and it enables UE access to some network as defined and allowed by credentials. In step 411, UE 401 is preconfigured with default UE credentials In step 412, UE 401 receives SIB broadcasting from NG RAN 402. When the SNPN supports Onboarding of UEs for SNPNs (e.g., the SNPN is used as ON-SNPN), the NG-RAN node additionally broadcasts the following information: an onboarding enabled indication that indicates whether onboarding is currently enabled for the SNPN. The onboarding enabled indication is broadcasted per cell, e.g., to allow start of the onboarding procedure only in parts of the SNPN.

In step 413, UE 401 performs ON-SNPN discover and selection, based on the received SIB broadcasting. Note that UE 401 may also be pre-configured with ON-SNPN selection information (in step 411), for the purpose of ON-SNPN selection. After the UE has selected an ON-SNPN for onboarding, in step 421, UE 401 initiates the onboarding registration procedure. In AS layer, the UE establishes an RRC connection towards the NG-RAN node 402 of the ON-SNPN. The UE provides an indication in the RRC connection establishment request message that the RRC connection is for onboarding. This indication allows the NG-RAN node 402 to select an appropriate AMF (e.g., target AMF 403) that supports the UE onboarding procedures. The UE indicates the ON-SNPN as the selected network, and the NG-RAN node indicate the selected PLMN ID and NID of the ON-SNPN to the AMF 403. In NAS layer, the UE initiates the NAS registration procedure by sending a NAS registration request message with the following characteristics: the UE shall set the 5GS Registration Type to the value “SNPN Onboarding” indicating that the registration request is for onboarding. In one novel aspect, this registration request message further indicates the UE-supported remote provision is either CP, UP, or both.

In step 422, NG RAN 402 selects AMF 403 as the target AMF for onboarding. In step 423, NG RAN 402 forwards the NAS registration request message to the target AMF 403. In step 431, the new target AMF 403 sends a UE context request message to an old source AMF 404, which has the UE context information. In step 432, the source AMF 404 sends a UE context response message, together with the UE context information back to the target AMF 403. In step 441, UE 401 performs onboarding registration with corresponding entities in the ON-SNPN. The other 5G NFs 505 may include AUSF, SMF etc. Based on the default UE credentials, the ON-SNPN may determine corresponding DCS identity or address/domain. The AMF 403 supporting UE onboarding is configured with AMF Onboarding Configuration Data for Onboarding, in order to restrict UE network usage to only onboarding.

When AMF 403 receives the NAS Registration Request with a 5GS Registration Type set to “SNPN Onboarding”, AMF 403 starts an authentication procedure towards the AUSF, applies the AMF Onboarding Configuration Data, and stores the UE context in the AMF indication that the UE is registered for SNPN onboarding. Upon successful authentication from AUSF, the AMF informs the UE about the result of the registration. If the UE is not successfully authenticated, the target AMF rejects the registration procedure for onboarding, and UE may selected a different ON-SNPN to register. In step 451, target AMF 403 sends a registration accept message to UE 401. In step 452, UE 401 sends a registration complete message to target AMF 403 to complete the registration procedure.

In step 461, upon successful registration, UE 401 follows the remote provisioning procedures (e.g., CP or UP) decided by the ON-SNPN to obtain the credentials from SO-SNPN via an onboarding network access connectivity to the PVS. The NG-RAN/base station facilitates such provisioning procedure by selecting the AMF and executing configuration based on UE provided information. A UP provisioning procedure is performed over a PDU session, while a CP provision procedure is performed over control plane messages, e.g., using UE parameters Update via UDM Control Procedure as specified in TS 23.502. Note that the ON-SNPN determines the provisioning procedure based on UE capability, as indicated in the registration request in step 421. In order to enable UP Remote Provisioning of SNPN credentials for a UE, UE Configuration Data for UP Remote Provisioning are either pre-configured on the UE or provided by the ON-SNPN. If Onboarding Services are provided using a restricted PDU session for remote provisioning of UE via User Plane, the AMF selects an SMF used for Onboarding Services using the SMF discovery and selection functionality. When the UE registered for Onboarding successfully completes the user plane remote provisioning of SNPN credentials via the ON-SNP, the UE should deregister from the ON-SNPN. The UE then use the obtained SNPN credentials to gain access to a specific SNPN, using normal registration procedure to get normal services from that specific SNPN.

FIG. 5 is a flow chart of a method of supporting onboarding registration procedure from UE perspective in accordance with one novel aspect. In step 501, a UE receives an indication from a serving base station in a stand-alone non-public network (SNPN). The indication indicates that Onboarding is enabled by the SNPN. In step 502, the UE transmits a registration request to the serving base station. The registration request indicates an Onboarding Registration type and one or more remote provisioning procedures supported by the UE603. In step 503, the UE performs an Onboarding registration to the SNPN with default UE credentials. In step 504, upon successful registration, the UE performs a selected remote provisioning procedure with the SNPN to obtain SNPN credentials.

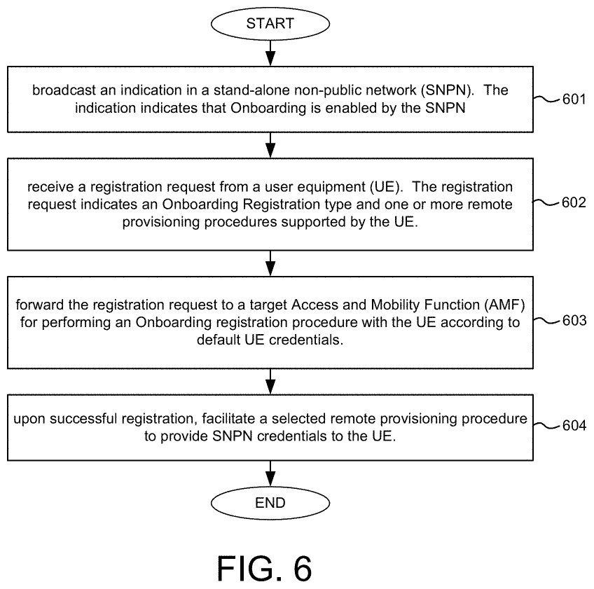

FIG. 6 is a flow chart of a method of supporting onboarding registration procedure from BS perspective in accordance with one novel aspect. In step 601, a base station broadcasts an indication in a stand-alone non-public network (SNPN). The indication indicates that Onboarding is enabled by the SNPN. In step 602, the base station receives a registration request from a user equipment (UE). The registration request indicates an Onboarding Registration type and one or more remote provisioning procedures supported by the UE. In step 603, the base station forwards the registration request to a target Access and Mobility Function (AMF) for performing an Onboarding registration procedure with the UE according to default UE credentials. In step 604, upon successful registration, the base station facilitates a selected remote provisioning procedure to provide SNPN credentials to the UE.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving an indication from a serving base station in a stand-alone non-public network (SNPN) by a user equipment (UE), wherein the indication indicates that Onboarding is enabled by the SNPN;
transmitting a registration request to the serving base station, wherein the registration request indicates an Onboarding Registration type and one or more remote provisioning procedures supported by the UE;
performing an Onboarding registration to the SNPN with default UE credentials; and
upon successful registration, performing a selected remote provisioning procedure with the SNPN to obtain SNPN credentials.

2. The method of claim 1, wherein the indication is broadcasted from the base station in system information block (SIB).

3. The method of claim 1, wherein the supported remote provisioning procedures comprises a user plane (UP) provisioning, a control plane (CP) provisioning, and both UP and CP provisioning.

4. The method of claim 3, wherein the UE establishes a protocol data unit (PDU) session to acquire the SNPN credentials under the UP provisioning.

5. The method of claim 3, wherein the UE uses a control plane signaling to acquire the SNPN credentials under the CP provisioning.

6. The method of claim 1, wherein the UE is pre-configured with the default UE credentials for the Onboarding registration.

7. The method of claim 1, wherein the SNPN credentials are obtained from a subscriber owner SNPN (SO-SNPN) via an onboarding SNPN access connectivity to a Provisioning Server (PVS).

8. A User Equipment (UE), comprising:
a receiver that receives an indication from a serving base station in a stand-alone non-public network (SNPN), wherein the indication indicates that Onboarding is enabled by the SNPN;
a transmitter that transmits a registration request to the serving base station, wherein the registration request indicates an Onboarding Registration type and one or more remote provisioning procedures supported by the UE;
a registration circuit that performs an Onboarding registration to the SNPN with default UE credentials; and
a control circuit that, upon successful registration, performs a selected remote provisioning procedure with the SNPN to obtain SNPN credentials.

9. The UE of claim 8, wherein the indication is broadcasted from the base station in system information block (SIB).

10. The UE of claim 8, wherein the supported remote provisioning procedures comprises a user plane (UP) provisioning, a control plane (CP) provisioning, and both UP and CP provisioning.

11. The UE of claim 10, wherein the UE establishes a protocol data unit (PDU) session to acquire the SNPN credentials under the UP provisioning.

12. The UE of claim 10, wherein the UE uses a control plane signaling to acquire the SNPN credentials under the CP provisioning.

13. The UE of claim 8, wherein the UE is pre-configured with the default UE credentials for the Onboarding registration.

14. The UE of claim 8, wherein the SNPN credentials are obtained from a subscriber owner SNPN (SO-SNPN) via an onboarding SNPN access connectivity to a Provisioning Server (PVS).

15. A method, comprising:
broadcasting an indication from a serving base station in a stand-alone non-public network (SNPN), wherein the indication indicates that Onboarding is enabled by the SNPN;
receiving a registration request from a user equipment (UE), wherein the registration request indicates an Onboarding Registration type and one or more remote provisioning procedures supported by the UE;
forwarding the registration request to a target Access and Mobility Function (AMF) for performing an Onboarding registration procedure with the UE according to default UE credentials; and
upon successful registration, facilitating a selected remote provisioning procedure to provide SNPN credentials to the UE.

16. The method of claim 15, wherein the indication is broadcasted from the base station in system information block (SIB).

17. The method of claim 15, wherein the supported remote provisioning procedures comprises a user plane (UP) provisioning, a control plane (CP) provisioning, and both UP and CP provisioning.

18. The method of claim 17, wherein the SNPN credentials are provided to the UE via a protocol data unit (PDU) session under the UP provisioning.

19. The method of claim 17, wherein a control plane signaling is used to acquire the SNPN credentials under the CP provisioning.

20. The method of claim 15, wherein the SNPN credentials are provided to the UE from a subscriber owner SNPN (SO-SNPN) via an onboarding SNPN access connectivity to a Provisioning Server (PVS).
